(19) United States
(12) Patent Application Publication
(10) Pub. No.: US 2024/0092136 A1
(43) Pub. Date: Mar. 21, 2024

(54) UNIVERSAL ELECTRONIC BYPASS CARTRIDGE ASSEMBLY AND METHOD

(71) Applicant: Off-Road Research LLC, Farmington Hills, MI (US)

(72) Inventor: Thomas J. Sawarynski, JR., West Bloomfield, MI (US)

(73) Assignee: Off-Road Research LLC, Farmington Hills, MI (US)

(21) Appl. No.: 18/470,701

(22) Filed: Sep. 20, 2023

Related U.S. Application Data
(60) Provisional application No. 63/408,450, filed on Sep. 20, 2022.

(51) Int. Cl. B60G 17/08; F16F 9/34; F16K 31/06; F16K 37/00

(52) U.S. Cl. CPC B60G 17/08; F16F 9/34; F16K 31/06; F16K 37/0041; F16K 2200/501

(57) ABSTRACT

An electronic bypass (eBypass) cartridge assembly and method for installing such, including a bypass valve defining a first chamber; a valve body defining a second chamber; and a check valve preventing flow from the second chamber to the first chamber. A bypass tube defining a third chamber, and a solenoid assembly, wherein the solenoid assembly controls flow between the first chamber, the second chamber, and the third chamber. The eBypass cartridge assembly may also include a cartridge attachment interface, and a sealing surface defined by the bypass valve, or an LVDT assembly configured to sense a position of bypass valve, or a valve seat formed on a spring housing, wherein the sealing surface is configured to seal to the valve seat in a fully closed position, or a single bypass input tube and a single bypass output tube.

### CROSS-REFERENCE TO RELATED APPLICATIONS

This application claims the benefit of U.S. Provisional Application No. 63/408,450, filed 20 Sep. 2022, which is hereby incorporated by reference in its entirety.

### TECHNICAL FIELD

The present disclosure pertains to an electronic bypass cartridge assembly for use in converting a passive bypass damper to a semi-active bypass damper, and to a system and method for dynamic control of the semi-active bypass damper including the electronic bypass cartridge assembly.

### BACKGROUND

A vehicle can be equipped with a suspension system including damping systems which provide a damping response to vehicle inputs. The damping system can include a passive damping system which includes a passive bypass damper assembly, and the damper assembly can also be referred to herein as a shock or shock assembly.

The vehicle owner or operator may wish to convert from the passive dampening system to a semi-active system. This would typically require replacement of the entire passive dampening system, including installation of replacement semi-active dampers, a control unit, additional controllers, and/or additional sensors to the vehicle, such that aftermarket semi-active systems are very costly.

However, an electronic bypass (eBypass) cartridge assembly, as described herein, is configured to drop in and replace the passive dampening system, the eBypass cartridge assembly is a drop-in replacement for the passive bypass poppet valve assembly. This system, therefore, allows a direct replacement with the minor the addition of controls via an electronic control unit (ECU) that provides computational resources in the form of an embedded microcontroller system.

### SUMMARY

An electronic bypass (eBypass) cartridge assembly, including a bypass valve defining a first chamber; a valve body defining a second chamber; and a check valve preventing flow from the second chamber to the first chamber. A bypass tube defining a third chamber, and a solenoid assembly, wherein the solenoid assembly controls flow between the first chamber, the second chamber, and the third chamber.

The eBypass cartridge assembly may also include a cartridge attachment interface, and a sealing surface defined by the bypass valve. The eBypass cartridge assembly may also include an LVDT assembly configured to sense a position of bypass valve. The eBypass cartridge assembly may also include a valve seat formed on a spring housing, wherein the sealing surface is configured to seal to the valve seat in a fully closed position.

The eBypass cartridge assembly may also include a single bypass input tube and a single bypass output tube, such that the eBypass cartridge assembly is operable to receive bypass fluid via substantially only the single bypass input tube and exit bypass fluid via substantially only the single bypass output tube. The eBypass cartridge assembly may also include a plug assembly and a control module configured to communicate with the plug assembly and thereby to control the solenoid assembly.

A method for semi-active control of a bypass damper using an electronic bypass (eBypass) system, may include removing a check valve housing of a passive bypass damper; installing an eBypass cartridge assembly to the check valve housing; and electronically connecting the eBypass cartridge assembly to a control module. The method may further include: sending control signals from the control module to the eBypass cartridge assembly to operatively control the eBypass cartridge assembly; removing multiple passive bypass dampers; and installing multiple eBypass cartridge assemblies; or sending control signals from the control module to the multiple eBypass cartridge assemblies.

The above features and advantages, and other features and advantages, of the present teachings are readily apparent from the following detailed description of some of the best modes and other embodiments for carrying out the present teachings, as defined in the appended claims, when taken in connection with the accompanying drawings.

### DESCRIPTION DRAWINGS

FIG. 1 is a schematic isometric view of an electronic bypass (eBypass) cartridge assembly or eBypass cartridge assembly.

FIG. 2 is a schematic another isometric view of an eBypass cartridge assembly.

FIG. 3 is a schematic a bottom isometric view of an eBypass cartridge assembly.

FIG. 4 is a schematic a flipped bottom isometric view of an eBypass cartridge assembly.

FIG. 5 is a schematic front view of an eBypass cartridge assembly.

FIG. 6 is a schematic back view of an eBypass cartridge assembly.

FIG. 7 is a schematic right side view of an eBypass cartridge assembly.

FIG. 8 is a schematic left side view of an eBypass cartridge assembly.

FIG. 9 is a schematic top view of an eBypass cartridge assembly.

FIG. 10 is a schematic bottom view of an eBypass cartridge assembly.

FIG. 11 is a schematic bottom view of an eBypass cartridge assembly showing cross section lines.

FIG. 12 is a schematic cross-sectional view of an eBypass cartridge assembly taken along line A-A of FIG. 11.

FIG. 13 is a schematic cross-sectional view of an eBypass cartridge assembly taken along line B-B of FIG. 11.

### DETAILED DESCRIPTION

Referring to the drawings wherein like reference numbers represent like components throughout the several figures. A universal electronic bypass (eBypass) cartridge assembly 100, eBypass assembly 100, or eBypass assemblies 100, which is interchangeable with a passive bypass damper to modify the bypass damper from the passive bypass damper to a semi-active bypass damper.

The eBypass assembly 100 may be connected to a vehicle dynamics control module 110, such as through a plug assembly 218—note that a corresponding plug is not shown. The corresponding plug, may typically, but without limitation, be two-wire plug for the actuator but could also be powered and locally controlled with integrated electronics at each eBypass assembly 100. The control signal may also be, without limitation: wireless, RF, optical, or other means of varying the control levels, as will be recognized by those having ordinary skill in the art.

A generalized control system, computing system, controller, or vehicle dynamics control module 110, which may be referred to simply as control module 110, is operatively in communication with relevant components of all systems, and recognizable by those having ordinary skill in the art. The controller includes, for example and without limitation, a non-generalized, electronic control device having a preprogrammed digital computer or processor, a memory, storage, or non-transitory computer-readable storage medium used to store data such as control logic, instructions, lookup tables, neural net logic, etc., and a plurality of input/output peripherals, ports, or communication protocols.

Furthermore, the controller may include, or be in communication with, a plurality of sensors. The controller is configured to execute or implement all control logic or instructions described herein and may be communicating with any sensors described herein or recognizable by skilled artisans. Any of methods described herein may be executed by one or more controllers.

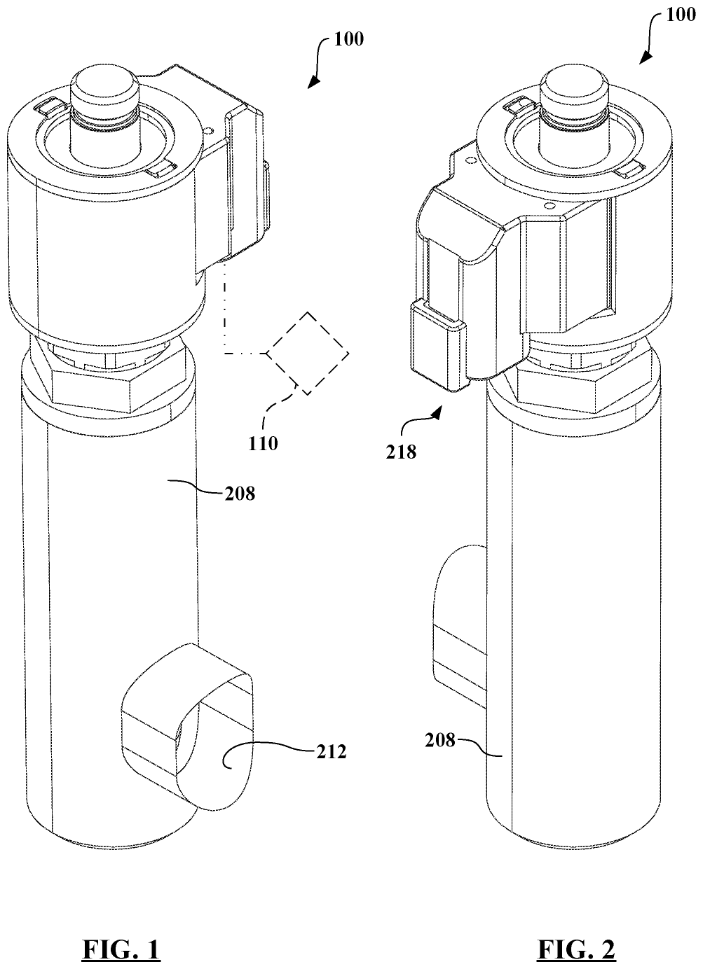

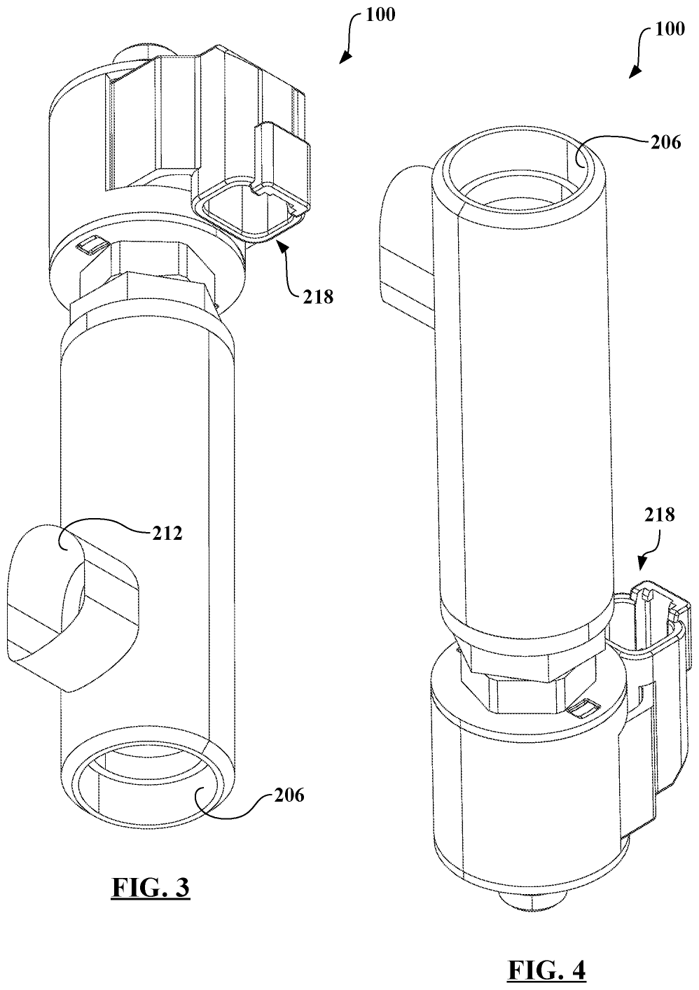

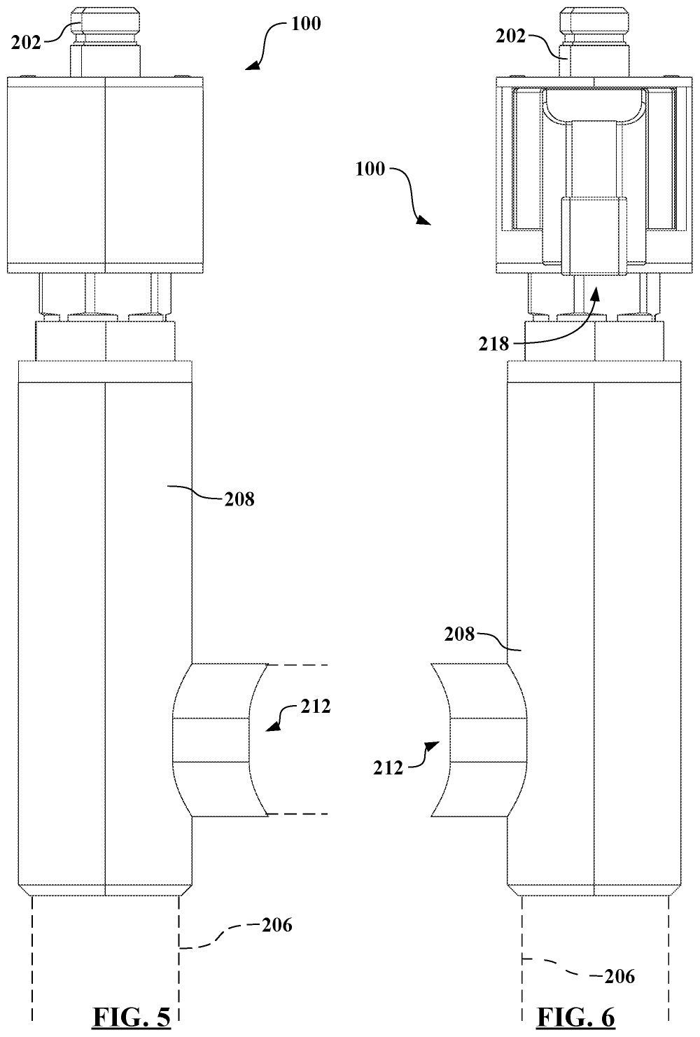

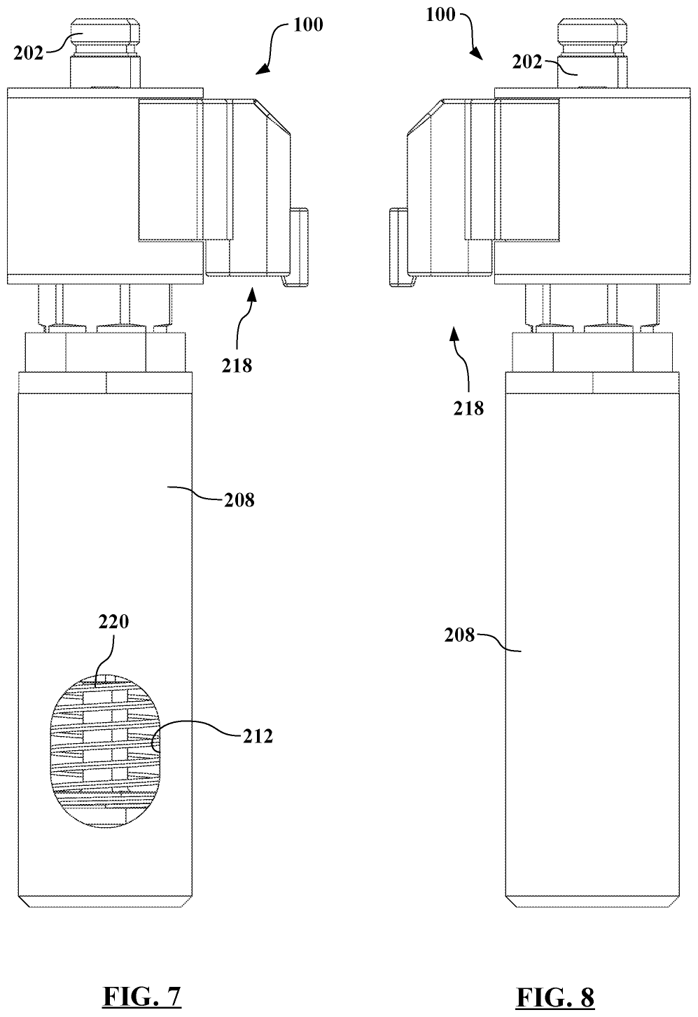

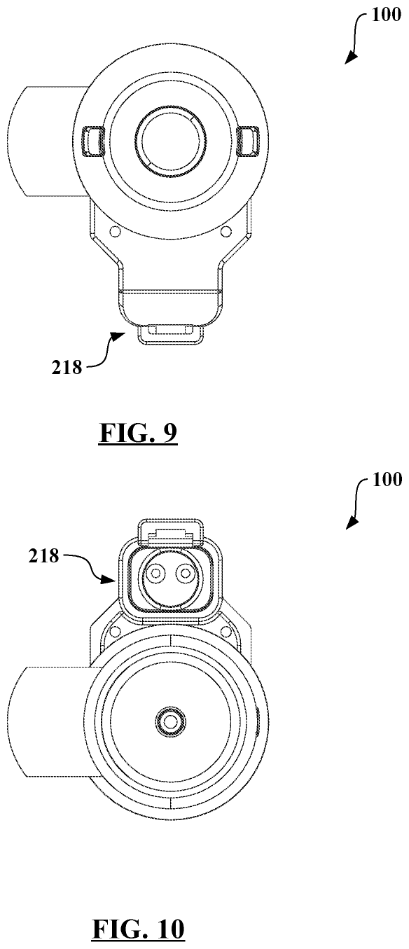

FIGS. 1-4 are various schematic isometric views of the eBypass assembly 100. FIG. 5 is a schematic front view of the eBypass assembly 100, and FIG. 6 is a schematic back view of the eBypass assembly 100. FIG. 7 is a schematic right side view of the eBypass assembly 100, and FIG. 8 is a schematic left side view of the eBypass assembly 100. FIG. 9 is a schematic top view of the eBypass assembly 100, FIG. 10 is a schematic bottom view of the eBypass assembly 100.

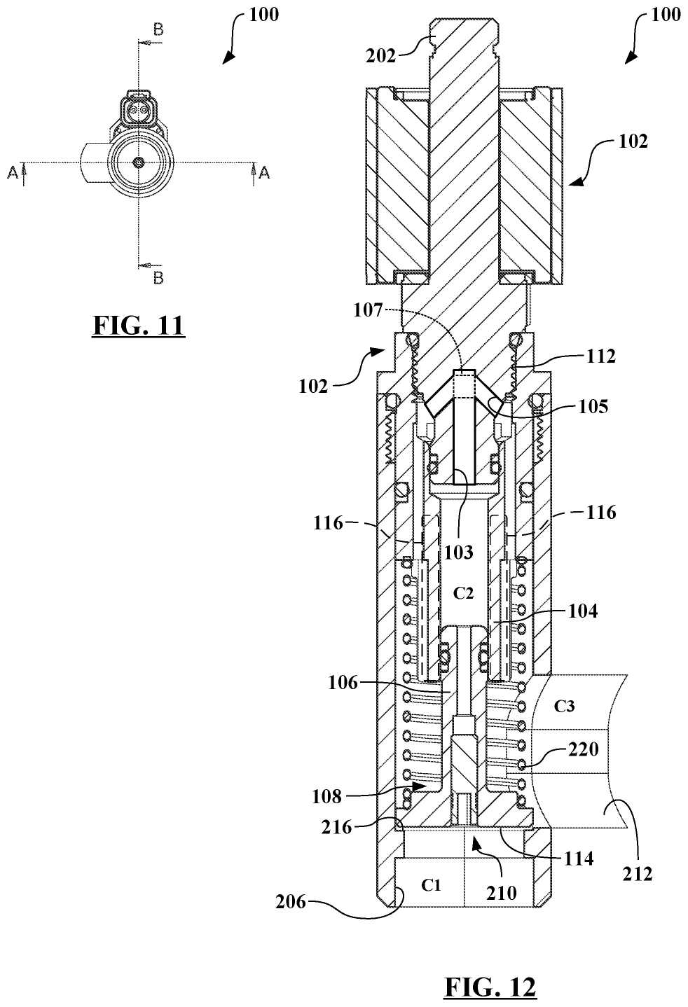

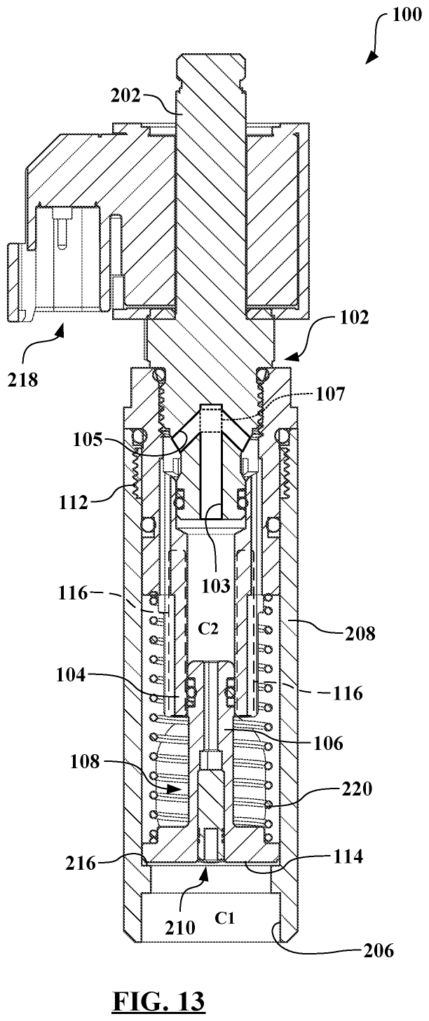

FIG. 11 is a schematic bottom view of the eBypass assembly 100 showing cross section lines. FIG. 12 is a schematic cross-sectional view of the eBypass assembly 100 taken along line A-A of FIG. 11. FIG. 13 is a schematic cross-sectional view of the eBypass assembly 100 taken along line B-B of FIG. 11.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting the claims or the description.

A typical bypass damper assembly may include a shock body which is fluidly connected to a remote reservoir, and further includes rebound and compression bypass tubes, each tube containing a check valve positioned in and attached to a check valve housing, each tube containing a bypass input tube and a bypass exit tube, such that fluid flows selectively through the bypass input tube, check valve, and bypass exit tube, as determined by the tuning of the check valve. At least one compression and/or at least one rebound and may include multiple passive bypass valves in conjunction with the eBypass assembly 100, which is typically installed in the longest compression/bypass tube. Multiple eBypass assemblies 100 may be installed in each compression/rebound circuit.

Bypass shocks work by allowing oil to flow through bypass tubes, around the main shock piston. The check valve only allows oil to flow in one direction, from the bypass input tube to the bypass exit tube. By stacking bypass tubes around the body at different heights the passive bypass shock will have softer and stiffer zones. The stiffness in each zone in the passive damping system is controlled by the diameter of the bypass tubes, and the tuning of the check valve, which determines how far the check valve is allowed to open—e.g., how far the bypass valve can separate from the valve seat. The check valve is generally tuned by making an external adjustment to the check valve assembly, for example, by manual adjustment of a setscrew to adjust the stopper plunger and as such, the opening and closing pressures of the check valve.

Once adjusted, the check valve will produce the same passive response to the bypass fluid, regardless of other vehicle inputs such as vehicle speed, steering inputs, vehicle load, braking inputs, and the like. The single response mode of a passive damper system does not provide the dynamic response which can be provided by a semi-active system.

The eBypass assembly 100 includes, without limitation: a bypass valve 108 defining a first chamber, which may be referred to as C1; a valve body 104 defining a second chamber, which may be referred to as C2; and a bypass tube 212 defining a third chamber, which may be referred to as C3.

A check valve assembly 210 substantially prevents flow from the second chamber to the first chamber. Skilled artisans will recognize the operation of check valve assembly 210 of many different types and configurations. A solenoid assembly 102 controls flow between the first chamber and the second chamber, which ultimately affects the third chamber.

The solenoid assembly 102 includes at least one inlet 103 and at least one outlet 105. Within the solenoid assembly 102—as would be recognized by those having ordinary skill in the art—there is a needle valve 107 that regulates the relief or delta pressure between the inlet 103 and outlet 105 of the solenoid assembly 102. Note that the needle valve 107, the inlet 103, and the outlet 105 are shown highly schematically in FIGS. 12 and 13.

The amount of current applied to the solenoid assembly 102 determines how much pressure is allowed to build at the inlet 103 before it relieves to the outlet 105, which is determined by one or more pressure and current curves. Skilled artisans will recognize application of current based on these pressure and current curves. Note that the solenoid assembly 102 coils are not separately numbered. The current applied by the solenoid assembly 102 provides an incremental preload closing force on the needle valve 107, which adds to the spring force and causes a higher delta pressure across inlet 103 and outlet 105 before it relieves. When the needle valve 107 pressure is overcome, by the pressure differential across inlet 103 and outlet 105, fluid is allowed to move between C2 to C3

Because a piston 106 of the bypass valve 108 is sealed with one or more O-rings to the valve body 104, when a main shock piston, which is attached to a shock rod 202, moves in a direction relative to the eBypass cartridge assembly 100, a delta pressure caused by the shock rod 202 tries to move the fluid in the bypass circuit between C1 to C3. Or other sealing mechanisms, glands, or generic seals typically used, will be recognized by those skilled in the art, for example, and without limitation: there are square, X, and other profiles other than O-rings that could be used. This flow generally occurs through one or more paths, which are not separately numbered.

Note that there are several O-rings in the figures, most of which are not numbered. The eBypass cartridge assembly 100 also includes a cartridge attachment interface 112, which may be, without limitation, threaded or otherwise attached.

A sealing surface 114 is defined by the bypass valve 108, and a valve seat 216 is formed on a spring housing 208. The sealing surface 114 is configured to seal to the valve seat 216 when the bypass valve 108 is in a fully closed position. Note that, in some configurations, the spring housing 208 and the bypass tube 212 may be retained from the previous passive bypass damper system.

The eBypass cartridge assembly 100 may include an LVDT assembly 116 operable to sense, or monitor, the position of the bypass valve 108 and/or the piston 106 thereof. The eBypass cartridge assembly 100 generally has a single bypass input tube 206 and a single bypass output tube, which may be the bypass tube 212. Therefore the eBypass cartridge assembly 100 is operable to receive bypass fluid via only the single bypass input tube 206 and exit bypass fluid via only the bypass tube 212. The eBypass cartridge assembly 100 is able to drop-in to an existing damper with single input tube 206 and single bypass tube 212, or single output tube, is what differentiates this from other competitors, which require modifying damper output tubes and including multiple output style tubes.

A spring coil 220 sits within the eBypass cartridge assembly 100 contained, generally, by the spring housing 208. Note that alternative to the spring coil 220, including, without limitation a wave spring, a gas spring, and others recognizable by those having ordinary skill in the art.

The term vehicle is broadly applied to any moving platform. Vehicles into which the disclosure may be incorporated include, for example and without limitation: passenger or freight vehicles; autonomous driving vehicles; industrial, construction, tracked, military, two-wheel, and mining equipment; and various types of aircraft.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be within 5%.

A method for semi-active control of a passive bypass damper using an electronic bypass (eBypass) system, may include some, or all, of the following: removing or replacing a check valve housing of a passive bypass damper, installing an eBypass assembly 100, and electronically connecting the eBypass assembly 100 to the control module 110. Additional steps may include, without limitation, cleaning damper components and pulling vacuum on the passive bypass damper or the eBypass assembly 100.

The control module 110 may incorporate numerous inputs including, without limitation: user inputs—such as mode requests—GPS settings, mobile application configuration settings, and/or telemetry and remote settings. The control module 110 may also incorporate numerous inputs including, without limitation: vehicle ground speed; roll, pitch, and/or yaw; steering parameters; throttle and/or torque requests; brake requests; individual wheel speeds; vehicle loading; or terrain detection; wheel position, strain, load, pressures, or other analogs—as would be recognized by skilled artisans—to infer relative position between sprung and un-sprung masses.

Advantages and benefits of the eBypass assembly 100 and methods, as described herein, are illustrated by the figures and description, and include, by way of non-limiting example: the first universal drop-in replacement for existing passive valves, allowing conversion to electronic dampers, that is not limited to any specific damper brand-agnostic—such that there is substantially universal application.

The installation of the eBypass assembly 100 does not require purchasing new dampers, thus increasing affordability to the vehicle owner/user, and it is applicable to motorsport, pre-runners, and daily driver vehicles. The system works for both the rebound and compression circuits, allowing for better vehicle platform control based on driver input or environmental conditions. There is a substantially minimal unique part count including solenoid, housing, check valve, and primary flow valve.

The installation of the eBypass assembly 100 reduces ride harshness as large flow area is available once pressure relief of the solenoid is exceeded. Note that the relief characteristics targets can be continuously varied in real time, such that different relief responses can be developed to emulate non-linear relief characteristics. Furthermore, the failure mode is system soft, reducing potential damage to other vehicle components should the eBypass assembly 100 fail to properly, or effectively, operate. The eBypass assembly 100 may also be configured as fail-firm should the application dictate it—i.e., military or motorsport may want to fail firm to prevent structural damage from crash-through with the system deactivated.

An electronic bypass (eBypass) cartridge assembly which is interchangeable with a passive bypass damper to modify the bypass damper from a passive bypass damper to a semi-active bypass damper, and a method of modifying a passive bypass damper to a semi-active bypass damper by replacing the bypass check valve with an eBypass cartridge assembly connected to a vehicle dynamics control module, is disclosed herein. The electronic bypass cartridge assembly described herein is also referred to herein as an eBypass cartridge assembly, an eBypass valve, and/or as an eBypass valve assembly. The eBypass cartridge is operable to be installed into a check valve housing of a passive damper assembly without modification of the check valve housing and/or the damper assembly to convert the passive damper assembly to a semi-active damper, such that the eBypass cartridge assembly is described herein as a universal replacement for a check valve in a passive bypass assembly.

An eBypass system and method described herein includes replacing the check valves of a passive bypass damper with one or more eBypass cartridge assemblies. The eBypass cartridge assemblies are in communication with a dynamics control module which receives inputs from user settings, vehicle parameters, and/or other vehicle sensors, and processes the inputs to output control signals in real time to the eBypass cartridge assemblies to control the semi-active operation of the converted bypass dampers.

In one example, the eBypass cartridge assemblies include Linear Variable Differential Transformer (LVDT) assemblies for sensing the bypass valve location, which is communicated to the control module for use in determining and outputting a control signal to the eBypass cartridge assembly. In one example, the rebound chamber pressure and the compression chamber pressure of the eBypass cartridge assemblies are sensed and communicated to the control module for use in determining and outputting a control signal to the eBypass cartridge assembly. Note that the delta pressure (P) between rebound and compression, multiplied by the main piston area (less rod area for rebound direction) is equivalent to the amount of force generated at the shock rod, which is in turn the damping force applied between the sprung and un-sprung masses—i.e., this is real time damping force control.

The above features and advantages, and other features and advantages, of the present teachings are readily apparent from the following detailed description of some of the best modes and other embodiments for carrying out the present teachings, as defined in the appended claims, when taken in connection with the accompanying drawings.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. An electronic bypass (eBypass) cartridge assembly, comprising:
a bypass valve defining a first chamber;
a valve body defining a second chamber;
a check valve preventing flow from the second chamber to the first chamber;
a bypass tube defining a third chamber; and
a solenoid assembly, wherein the solenoid assembly controls flow between the first chamber, the second chamber, and the third chamber.

2. The eBypass cartridge assembly of claim 1, further comprising:
a cartridge attachment interface; and
a sealing surface defined by the bypass valve.

3. The eBypass cartridge assembly of claim 2, further comprising:
an LVDT assembly configured to sense a position of the bypass valve.

4. The eBypass cartridge assembly of claim 3, further comprising:
a valve seat formed on a spring housing, wherein the sealing surface is configured to seal to the valve seat in a fully closed position.

5. The eBypass cartridge assembly of claim 4, further comprising:
a single bypass input tube; and
a single bypass output tube, wherein the eBypass cartridge assembly is operable to:
receive bypass fluid via substantially only the single bypass input tube; and
exit bypass fluid via substantially only the single bypass output
tube.

6. The eBypass cartridge assembly of claim 5, further comprising:
a plug assembly.

7. The eBypass cartridge assembly of claim 6, further comprising:
a control module configured to communicate with the plug assembly and thereby to control the solenoid assembly.

8. The eBypass cartridge assembly of claim 2, further comprising:
a valve seat formed on a spring housing, wherein the sealing surface is configured to seal to the valve seat in a fully closed position.

9. The eBypass cartridge assembly of claim 8, further comprising:
an LVDT assembly configured to monitor a location of the bypass valve.

10. The eBypass cartridge assembly of claim 9, further comprising:
a plug assembly.

11. The eBypass cartridge assembly of claim 10, further comprising:
a control module configured to communicate with the plug assembly and thereby to control the solenoid assembly.

12. A method for semi-active control of a bypass damper using an electronic bypass (eBypass) system, comprising:
removing a check valve housing of a passive bypass damper;
installing an eBypass cartridge assembly to the check valve housing; and
electronically connecting the eBypass cartridge assembly to a control module.

13. The method of claim 12, further comprising:
sending control signals from the control module to the eBypass cartridge assembly to operatively control the eBypass cartridge assembly.

14. The method of claim 13, further comprising:
removing multiple passive bypass dampers; and
installing multiple eBypass cartridge assemblies.

15. The method of claim 14, further comprising:
sending control signals from the control module to the multiple eBypass cartridge assemblies.
